(19) United States
(12) Patent Application Publication
(10) Pub. No.: US 2009/0174681 A1
(43) Pub. Date: Jul. 9, 2009

(54) LIQUID CRYSTAL DISPLAY PANEL AND TOUCH PANEL THEREFOR

(75) Inventors: Jong-Woong CHANG, Cheonan-si (KR); Byoung-Jun LEE, Cheonan-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/277,739

(22) Filed: Nov. 25, 2008

(30) Foreign Application Priority Data
Jan. 4, 2008 (KR) 10-2008-0001205

(51) Int. Cl. G06F 3/041

(52) U.S. Cl. 345/173

(57) ABSTRACT

A display panel includes a first substrate, a touch spacer, a common electrode and a sensing electrode. The second substrate faces the first substrate, the touch spacer is disposed on a first substrate, the common electrode is disposed on the touch spacer, and the sensing electrode is disposed on a second substrate directly under the touch spacer. A surface, facing the first substrate, of the sensing electrode includes protrusions which protrude toward the first substrate.

This application claims priority to Korean Patent Application No. 2008-1205, filed on Jan. 4, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display panel. More particularly, the present invention relates to a liquid crystal display having a touch panel which prevents an error in detecting coordinates corresponding to touched points on the touch panel.

2. Description of the Related Art

In general, a touch panel is used as an input device for a display apparatus such as a liquid crystal display, a field emission display, a plasma display panel or an electro-luminescence display, for example.

Based on an operating method of a touch panel, the touch panel may be classified as either a capacitance touch panel or a resistance film touch panel. Specifically, the capacitance touch panel detects an electric charge developed between a transparent conductive film and a stylus which makes contact with the transparent conductive film. The capacitance touch panel calculates a coordinate value based on a value of the electric charge developed between the transparent conductive film and the stylus. To develop the electric charge, however, the stylus of the capacitance touch panel requires a separate power source and, as a result, the resistance film touch panel is typically used as an input device instead of the capacitance touch panel.

The resistance film touch panel detects a current variation or, alternatively, a voltage variation, developed at a contact point of two opposite conductive layers. Specifically, a first voltage is applied to a first conductive layer and a second voltage is applied to a second conductive layer facing the first conductive layer. When a user presses the resistance touch panel, the first conductive layer contacts the second conductive layer, and a coordinate value is determined based on a detected current variation or a detected voltage variation developed at a point where the user presses the resistance touch panel.

The resistance film touch panel is used as an input device in a liquid crystal display, for example. The liquid crystal display generally includes a thin film transistor substrate and a color filter substrate disposed opposite to the thin film transistor substrate. A first sensing electrode is electrically connected to a first sensing line. A second sensing electrode is electrically connected to a second sensing line. The first sensing electrode and the second sensing electrode are both formed on the thin film transistor substrate.

The color filter substrate includes a touch spacer which makes electrical contact with the first sensing electrode and the second sensing electrode when pressure is applied to the liquid crystal display, to thereby determine coordinates of a contact point at which the pressure is applied. More specifically, a first coordinate, which indicates an x-axis contact point, and a second coordinate, which indicates a y-axis contact point, is determined based on a signal generated when the touch spacer makes electrical contact with the first sensing electrode and the second sensing electrode.

In the liquid crystal display, an alignment layer is disposed above both the first sensing electrode and the second sending electrode. The alignment layer is disposed between the thin film transistor substrate and the color filter substrate. Since the alignment layer is disposed between the thin film transistor substrate and color filter substrate, the first sensing electrode and the second sensing electrodes do not contact the touch spacer simultaneously when the pressure is applied to the liquid crystal display panel. As a result contact sensitivity of the resistance touch panel is lowered.

Thus, it is desired to develop a liquid crystal display having improved contact sensitivity.

### BRIEF SUMMARY OF THE INVENTION

An exemplary embodiment of the present invention provides a display panel capable of easily detecting coordinate positions and improving contact sensitivity.

In an exemplary embodiment of the present invention, a display panel includes a first substrate, a second substrate facing the first substrate, a touch spacer disposed on the first substrate, a common electrode disposed on the touch spacer, and a sensing electrode disposed on the second substrate facing the touch spacer, and a surface, facing the first substrate, of the sensing electrode has a step difference.

The sensing electrode has an embossed shape which allows at least two protrusions of plural protrusions of the sensing electrode to make contact with the common electrode.

The display panel may further include a lower electrode disposed between the sensing electrode and the second substrate. The shape of the lower electrode comprises one of a circular shape, an oval shape and a polygonal shape.

The second substrate includes a first sensing line, a gate line including a gate electrode and being disposed in a same layer as the first sensing line, a gate insulating layer disposed on the first sensing line and the gate line, a semiconductor layer disposed on the gate insulating layer and which overlaps the gate electrode, a second sensing line disposed on the gate insulating layer, a data line disposed in a same layer as the second sensing line and on the semiconductor layer, a protective layer disposed on the data line and including a contact hole formed therein, a portion of the data line being exposed through the contact hole, and a pixel electrode disposed on the protective layer and which contacts the portion of the data line through the contact hole. The lower electrode may include a same material as a material of at least one of the gate line and the data line.

In another exemplary embodiment of the present invention, a display panel includes a first substrate, a second substrate facing the first substrate, a touch spacer disposed on the first substrate, a common electrode disposed on the touch spacer, a first sensing line disposed facing a first portion of the touch spacer on the second substrate, a second sensing line disposed facing a second portion, different from the first portion, of the touch spacer on the second substrate, a first sensing electrode connected to the first sensing line and a second sensing electrode connected to the second sensing line, each of the first sensing electrode and second sensing electrode have an embossed shape including at least one protrusion which protrudes toward the common electrode.

Each of the first sensing electrode and the second sensing electrode has an embossed shape which allows at least two protrusions thereof to make contact the common electrode.

The display panel may further include a first lower electrode disposed between the first sensing electrode and the second substrate, and a second lower electrode disposed between the second sensing electrode and the second substrate. The first and second lower electrodes may have one of a circular shape, an oval shape and a polygonal shape. And the first lower electrode and the second lower electrode are disposed in one of a same layer as each other and a different layer from each other.

The second substrate further includes a gate line disposed in a same layer as the first sensing line and which includes a gate electrode, a gate insulating layer disposed on the first sensing line and the gate line, a semiconductor layer disposed on the gate insulating layer and which overlaps the gate electrode, a data line disposed in a same layer as the second sensing line on the semiconductor layer, a protective layer disposed on the data line and which includes a contact hole formed therethrough, a portion of the data line is being exposed through the contact hole, and a pixel electrode disposed on the protective layer, wherein the pixel electrode makes contacts with the data line through the contact hole.

Each of the first lower electrode and the second lower electrode include a same material as a material of at least one of the gate line and data line. A plurality of protrusions of the first sensing electrode protrudes toward a plurality of protrusions of the second sensing electrode in a plan view.

In another exemplary embodiment of the present invention, a display panel includes a first substrate, a second substrate facing the first substrate, a touch spacer disposed on the first substrate, a common electrode disposed on the touch spacer, a first sensing line disposed on the second substrate, a second sensing line disposed on the second substrate, and a sensing electrode connected to the first sensing line and the second sensing line, the sensing electrode including protrusions which protrude toward the common electrode to make contact with the common electrode.

The display panel may further include a lower electrode disposed between the sensing electrode and the second substrate.

The lower electrode has a size less than a corresponding size of the sensing electrode.

The lower electrode may be formed using a same material as a material of the second sensing line and disposed in a same layer as the second sensing line.

The second substrate may further include a gate line disposed in a same layer as the first sensing line and which includes a gate electrode, a gate insulating layer disposed on the first sensing line and the gate line, a semiconductor layer disposed on the gate insulating layer and which overlaps the gate electrode, a data line disposed in a same layer as the second sensing line, a protective layer disposed on the data line and which includes a contact hole formed therethrough, a portion of the data line being exposed through the contact hole, and a pixel electrode disposed on the protective layer and which contacts the data line through the contact hole.

The semiconductor layer may be disposed between the lower electrode and the second substrate, and a portion of the semiconductor layer overlaps the lower electrode.

According to the above, the display panel includes the sensing electrode having the embossed shape, which allows a plurality of portions of the sensing electrode to facilitate contact with the common electrode when pressure is applied to the touch spacer. Therefore, the display panel may reduce a sensitivity difference caused by a difference in a contact region, and damage the touch spacer by local stress concentration may be prevented.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a plan view of a display panel according to an exemplary embodiment of the present invention;

FIG. 2 is a partial cross-sectional view taken along line I-I′ of FIG. 1;

FIGS. 3A to 3C are partial cross-sectional views taken along line II-II′ of FIG. 1;

FIGS. 4 to 9 are plan views showing alternative exemplary embodiments of a lower electrode of the display panel according to the exemplary embodiment of the present invention shown in FIG. 1;

FIG. 10 is a plan view of a display panel according to an alternative exemplary embodiment of the present invention;

FIG. 11 is a partial cross-sectional view taken along line III-III′ of FIG. 10; and

FIG. 12 is a plan view of a lower electrode of the display panel according to the alternative exemplary embodiment of the present invention shown in FIG. 10.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly if the device in one of the figures is turned over, elements described as “below” or “beneath” other elements would then be oriented “above” the other elements. The exemplary terms “below” or “beneath” can, therefore, encompass both an orientation of above and below.

Hereinafter, exemplary embodiments of the present invention will be explained in further detail with reference to the accompanying drawings.

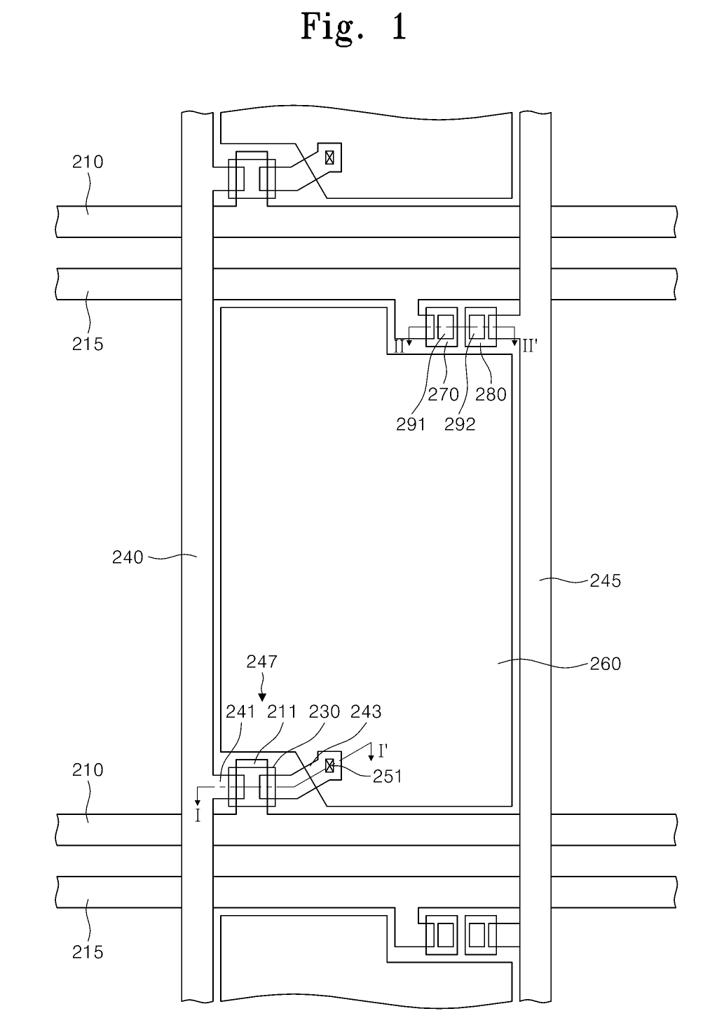

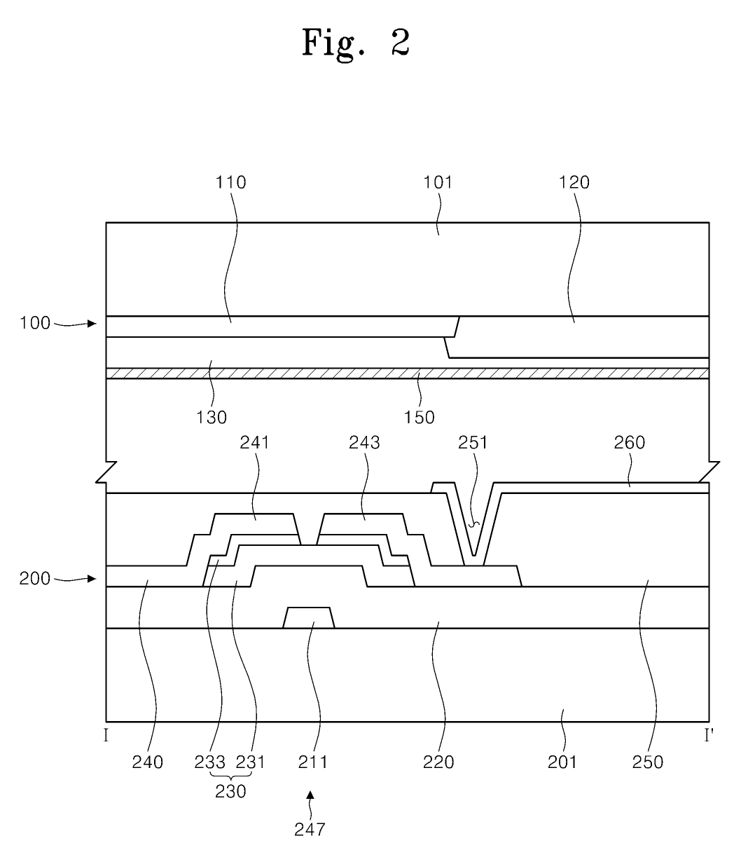

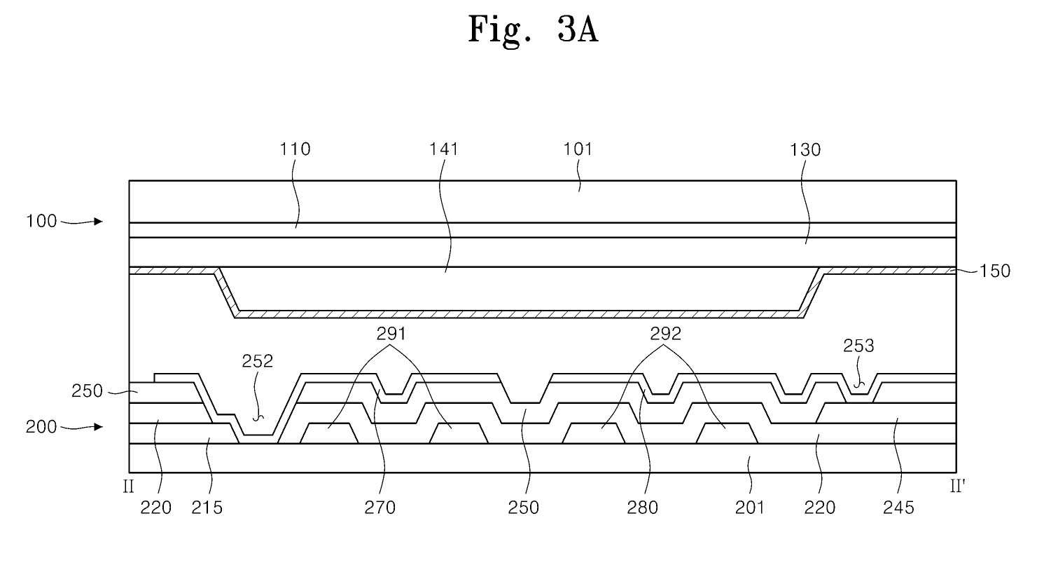

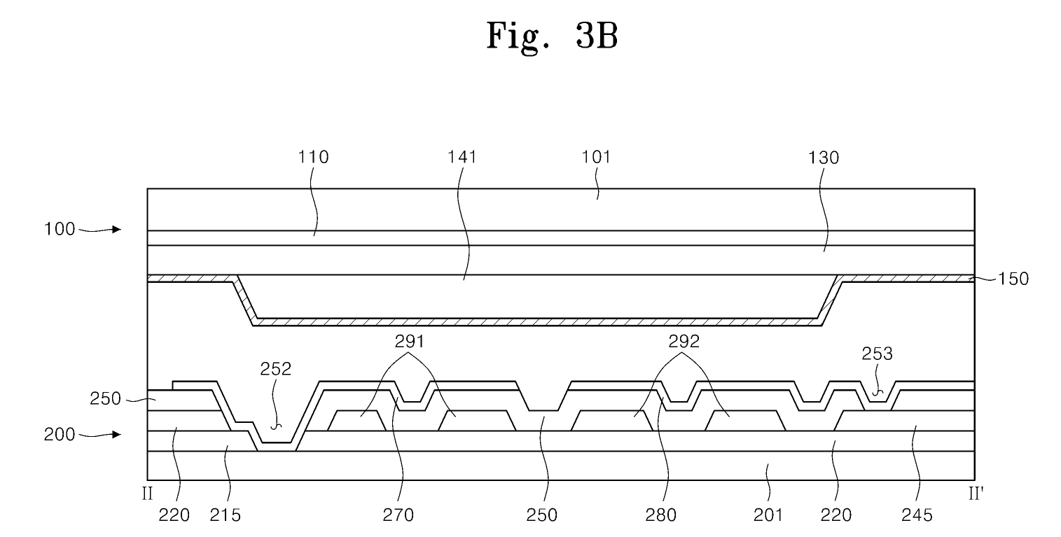

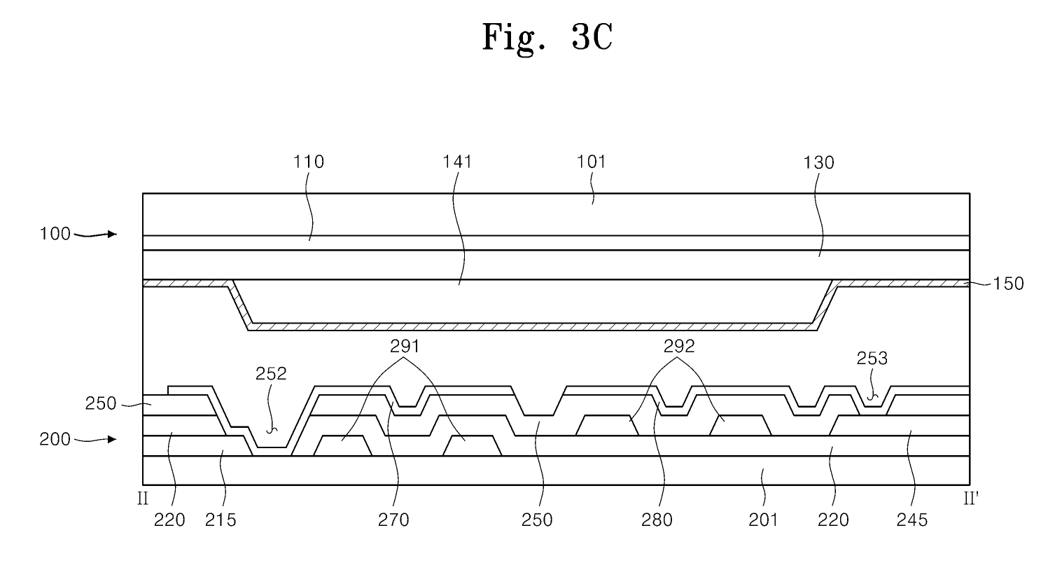

FIG. 1 is a plan view of a display panel according to an exemplary embodiment of the present invention, and FIG. 2 is a partial cross-sectional view taken along line I-I′ of FIG. 1, and FIGS. 3A to 3B are partial cross-sectional views taken along a line II-II′ of FIG. 1.

Referring to FIGS. 1 to 3A, a display panel according to an exemplary embodiment of the present invention includes a first substrate 100 and a second substrate 200 facing the first substrate 100.

In further detail, the first substrate 100 includes an upper substrate 101, a black matrix 110 for preventing light leakage through the upper substrate 101, a color filter 120 for implementing color display, an overcoat layer 130 reducing a step difference between the black matrix 110 and the color filter 120, and a common electrode 150 which applies a common voltage to a liquid crystal (not shown), as illustrated in FIG. 2.

The upper substrate 101 includes a transparent insulating material such as plastic, for example, so that the upper substrate 101 is flexible, for example, may be bent when pressure is applied thereto.

The black matrix 110 according to an exemplary embodiment includes a non-transparent organic material or, alternatively, a non-transparent metal to prevent light from leaking through a region in which the liquid crystal is not controlled, for example, a region in which the black matrix 110 is disposed.

The color filter 120 includes a red color filter, a green color filter and a blue color filter, but alternative exemplary embodiments of the present invention are not limited thereto.

The overcoat layer 130 includes a transparent organic material for improved step coverage and for insulation of the common electrode 150. The overcoat layer 130 protects the color filter 120 and the black matrix 110.

The common electrode 150 is arranged on the overcoat layer 130 and includes a transparent metal such as indium tin oxide (“ITO”) or indium zinc oxide (“IZO”), for example.

Referring to FIG. 3A, a touch spacer 141 is arranged between the common electrode 150 and the overcoat layer 130. In further detail, the touch spacer 141 is arranged on the overcoat layer 130 and is substantially covered by the common electrode 150. In addition, a first sensing electrode 270 and a second sensing electrode 280 are each disposed on the second substrate 200. The touch spacer 141 is formed to have a predetermined height, for example, a predetermined height protruding from the first substrate 100 toward the second substrate 200, so that contact occurs between the common electrode 150 and a first sensing electrode 270 when pressure is applied on an upper surface of the upper substrate 101 by a user with a finger, or a pen or stylus, for example. The touch spacer 141 according to an exemplary embodiment may include a conductive material to apply a voltage or, alternatively, a current between the first sensing electrode 270 and the second sensing electrode 280 and the common electrode 150, if the common electrode 150 is damaged.

Still referring to FIGS. 1-3A, the second substrate 200 includes a lower substrate 201, a gate line 210, a first sensing line 215, a data line 240, a second sensing line 245, a thin film transistor 247, a pixel electrode 260, the first sensing electrode 270, the second sensing electrode 280, a first lower electrode 291 and a second lower electrode 292.

The gate line 210 extends in a first direction, for example, a substantially horizontal direction (as shown in FIG. 1) on the lower substrate 201 and includes a gate electrode 211 branching in a second direction opposite the first direction, for example, a substantially vertical direction, from the gate line 210.

The first sensing line 215 is arranged in the first direction substantially in parallel with the gate line 210. The first sensing line 215 is also spaced apart from the gate line 210 by a predetermined distance, measured along the second direction, and, in an exemplary embodiment, includes a same material as a material of the gate line 210.

Referring to FIGS. 1 and 2, the data line 240 extends in the second direction, for example, the vertical direction, on the lower substrate 201. The data line 240 includes a source electrode 241 branching in the first direction from the data line 240, and a drain electrode 243 spaced apart from the source electrode 241. The source electrode 241 and the drain electrode 243 partially overlap the gate electrode 211, as shown in FIG. 2.

The second sensing line 245 extends in the first direction substantially in parallel with the data line 240. In an exemplary embodiment, the second sensing line 245 includes a same material as a material of the data line 240.

Still referring to FIGS. 1 and 2, the thin film transistor 247 is turned on in response to a gate signal applied through the gate line 210 so that a pixel voltage applied through the data line 240 is charged to the pixel electrode 260. The thin film transistor 247 includes the gate electrode 211 connected to the gate line 210, the source electrode 241 connected to the data line 240 and spaced apart from the drain electrode 243 by a predetermined distance, and the drain electrode facing the source electrode 241 and connected to the pixel electrode 260.

Also, the thin film transistor 247 includes a semiconductor layer 230, which overlaps the gate electrode 211 with the gate insulating layer 220 interposed therebetween. The semiconductor layer 230 forms a channel between the source electrode 241 and the drain electrode 243.

In detail, the semiconductor layer 230, as illustrated in FIG. 2, includes an active layer 231, which forms the channel between the source electrode 241 and the drain electrode 243 and overlaps the gate electrode 211 while having the gate insulating layer 220 interposed therebetween. The semiconductor layer 230 further includes an ohmic contact layer 233 disposed on the active layer 231 to thereby allow each of the data line 240, the source electrode 241 and the drain electrode 243 disposed on the active layer 231 to make contact with the ohmic contact layer 233.

Referring to FIGS. 2 and 3A, the protective layer 250 according to an exemplary embodiment includes an inorganic material such as nitride silicon (“SiNx”) or oxide silicon (“SiOx”), for example, or an organic material such as acrylic, polyimide or benzoclylobutene (BCB), for example. Further, the protective layer 250 according to an exemplary embodiment has a single-layer structure or, alternatively, a multi-layer structure including the inorganic material and/or the organic material. The protective layer 250 is formed to cover the thin film transistor 247 and the gate insulting layer 220 to insulate the thin film transistor 247 from the pixel electrode 260.

The protective layer 250 includes a first contact hole 251, a second contact hole 252 and a third contact hole 253, each formed in the protective layer 250 as shown in FIGS. 2 and 3A. The first contact hole 251, the second contact hole 252 and the third contact hole 253 partially expose the drain electrode 243, the first sensing line 215, and the second sensing line 245, respectively. The first contact hole 251, the second contact hole and the third contact hole 253 are formed by partially etching the protective layer 250 using a mask, for example, but alternative exemplary embodiments are not limited thereto.

Referring to FIG. 2, the pixel electrode 260 is disposed on the protective layer 250 and is connected to the drain electrode 243 of the thin film transistor 247 through the first contact hole 251. The pixel electrode 260 also includes a transparent and conductive material such as ITO, IZO, or indium tin zinc oxide (“ITZO”), for example.

The first sensing electrode 270 and second sensing electrode 280 are connected to the first sensing line 215 and the second sensing lines 245, respectively, as illustrated in FIGS. 1 and 3A.

The first sensing electrode 270 is connected to the first sensing line 215 through the second contact hole 252, which penetrates through the protective layer 250 and the gate insulating layer 220. The first sensing electrode 270 may be formed to have a predetermined shape and may be disposed apart from the second sensing electrode 280, as shown in FIG. 3A. For example, the first sensing electrode 270 according to an exemplary embodiment of the present invention includes a angled sides, with respect to a plane defined by the lower substrate 210, facing corresponding angled sides of the second sensing electrode 280.

The second sensing electrode 280 is connected to the second sensing line 245 through the third contact hole 253, which penetrates through the protective layer 250. The second sensing electrode 280 may be formed to have a predetermined shape. Further, the second sensing electrode 280 may be disposed on the gate insulating layer 220 and the protective layer 250 at a same height as a height of the first sensing electrode 270. Therefore, the first sensing electrode 270 and the second sensing electrode 280 uniformly contact the touch spacer 141 when pressure is applied to the upper surface of the upper substrate 101, as described above.

The first lower electrode 291 and second lower electrode 292 are disposed under the first sensing electrode 270 and the second sensing electrodes 280, respectively. A size of the first lower electrode 291 is less than a size of the first sensing electrode 270, and a size of the second lower electrode 292 is less than a size of the second sensing electrode 280. Thus, a step difference occurs at the first sensing electrode 270 and the second sensing electrode 280 due to the smaller size of the first lower electrode 291 and the smaller size of the second lower electrode 292. As a result, the first lower electrode 291 and second lower electrode 292 allow the first sensing electrode 270 and second sensing electrode 280 to protrude, for example, the first sensing electrode 270 and second sensing electrode 280 have an embossed shape, as shown in FIG. 3A.

The first lower electrode 291 and second lower 292 may comprise a same material as a material of at least one of the gate line, the data line, and the semiconductor layer. In detail, the first lower electrode 291 and second lower electrode 292 may be formed using at least one of a gate metal, a data metal, and a semiconductor material. For example, the first lower electrodes 291 and second lower electrodes 292 may be formed using the same gate metal as the first sensing line 215 shown in FIG. 3A. In addition, the first lower electrode 291 and the second lower electrode 292 may be formed using the same data metal as the second sensing line 245, shown in FIG. 3B. Further, the first lower electrode 291 and second lower electrode 292 may be formed using the same gate metal and data metal as those of the first sensing line 215 and the second sensing line 245, respectively, as shown in FIG. 3C. In an alternative exemplary embodiment, when the first lower electrode 291 and second lower electrode 292 are formed using the data metal, the semiconductor layer 230 maybe disposed under the first lower electrodes 291 and second lower electrodes 292.

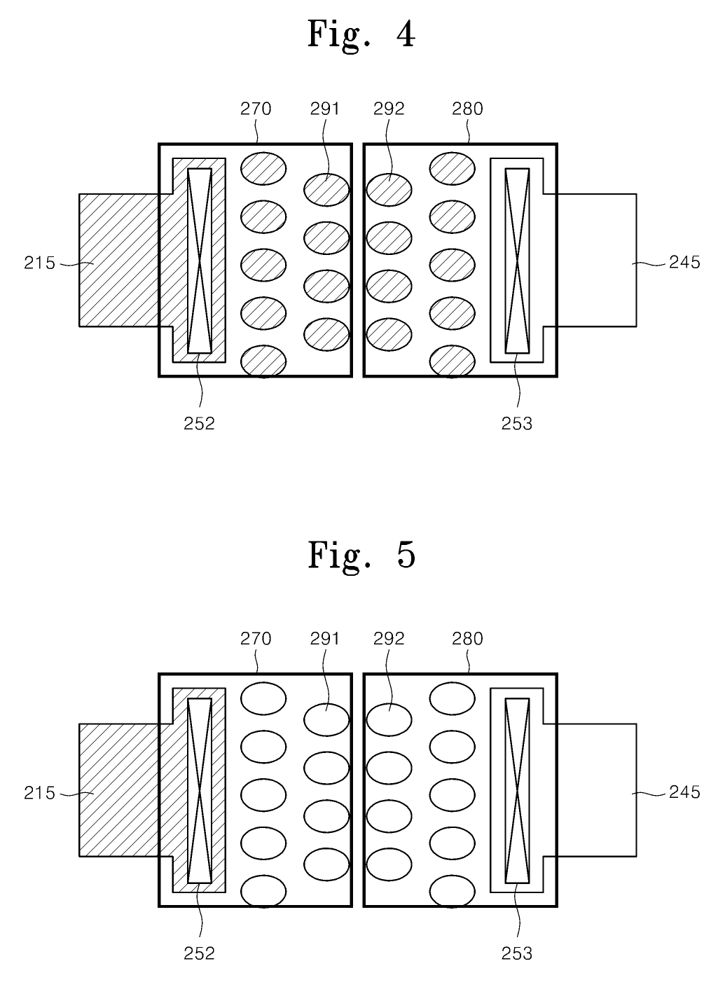

The first lower electrode 291 and the second lower electrode 292 may be formed in a circular shape, an oval shape or a polygonal shape, as will be described in further detail below with reference to FIGS. 4 to 9.

In an exemplary embodiment of the present invention, the step difference is formed due to the first lower electrode 291 and the second lower electrode 292, which are disposed under the first sensing electrode 270 and second sensing electrode 280, respectively. However, the step difference may be formed by patterning the gate insulating layer 220 and/or the protective layer 250.

As described above, the display panel varies resistance according to a contact point when pressure is applied by to the upper substrate 101. As a result, the first sensing electrode 270 and the second sensing electrode 280 contact the common electrode 150 disposed on the touch spacer 141. Thus, the display panel outputs a current or voltage based on an x-axis coordinate signal through the first sensing line 215, and outputs a current or voltage based on a y-axis coordinate signal through the second sensing line 245. Specifically, the current or voltage of the display panel is varied according to the varied resistance. In addition, the display panel detects the coordinates using the output coordinate signals through a driving circuit (not shown).

Hereinafter, the lower electrode 291 of the display panel according to an exemplary embodiment of the present invention will be described in further detail with reference to FIGS. 4 to 9.

FIGS. 4 to 9 are plan views showing alternative exemplary embodiments of the lower electrode of the display panel according to the exemplary embodiment of the present invention shown in FIG. 1.

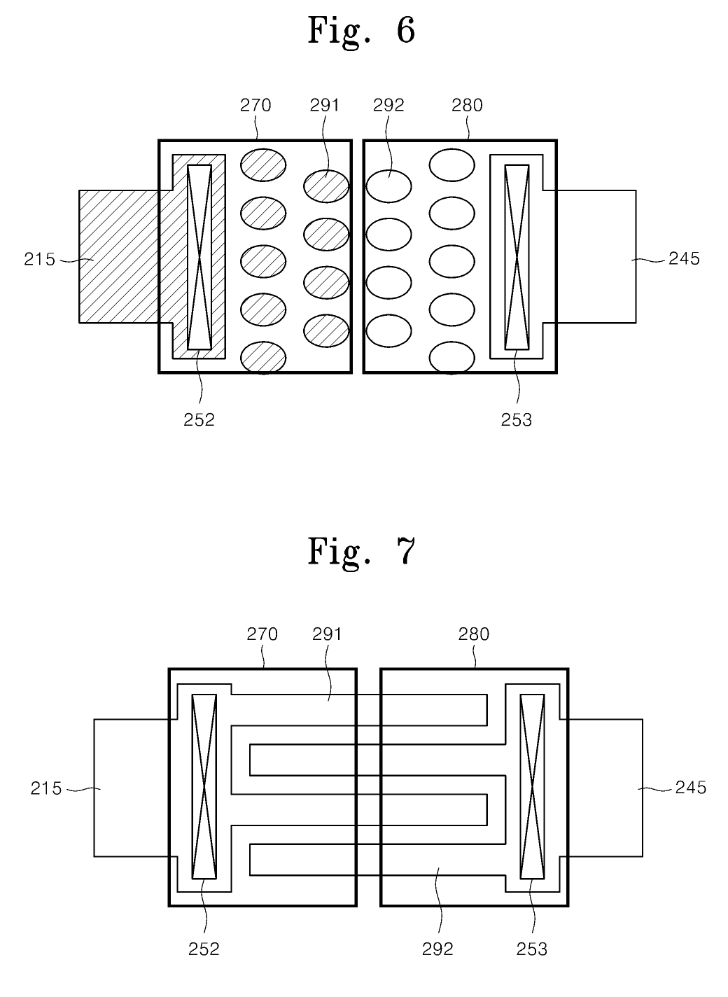

Referring to FIGS. 4 to 6, the first lower electrode 291 and second lower electrode 292 according to an exemplary embodiment are formed in a circular shape. The first lower electrode 291 and second lower electrode 292 may include a same material as the first sensing line 215, shown in FIG. 4. In addition, the first lower electrode 291 and the second lower electrode 292 may include a same material as the second sensing line 245, shown in FIG. 5. Further, the first lower electrode 291 and second lower electrode 292 may include a same material as the first sensing line 215 and the second sensing line 245, respectively, shown in FIG. 6. Referring to FIG. 6, the first lower electrode 291 and the second lower electrode 292 according to an exemplary embodiment are disposed under the first sensing electrode 270 and second sensing electrode 280, respectively.

It will be noted that alternative exemplary embodiments of the first lower electrode 291 and the second lower electrode 292 are not limited to the above-described materials and/or shapes. For example, the first lower electrode 291 and the second lower electrode 292 according to an alternative exemplary embodiment may include the same materials as the first sensing line 215 and the second sensing line 245, respectively.

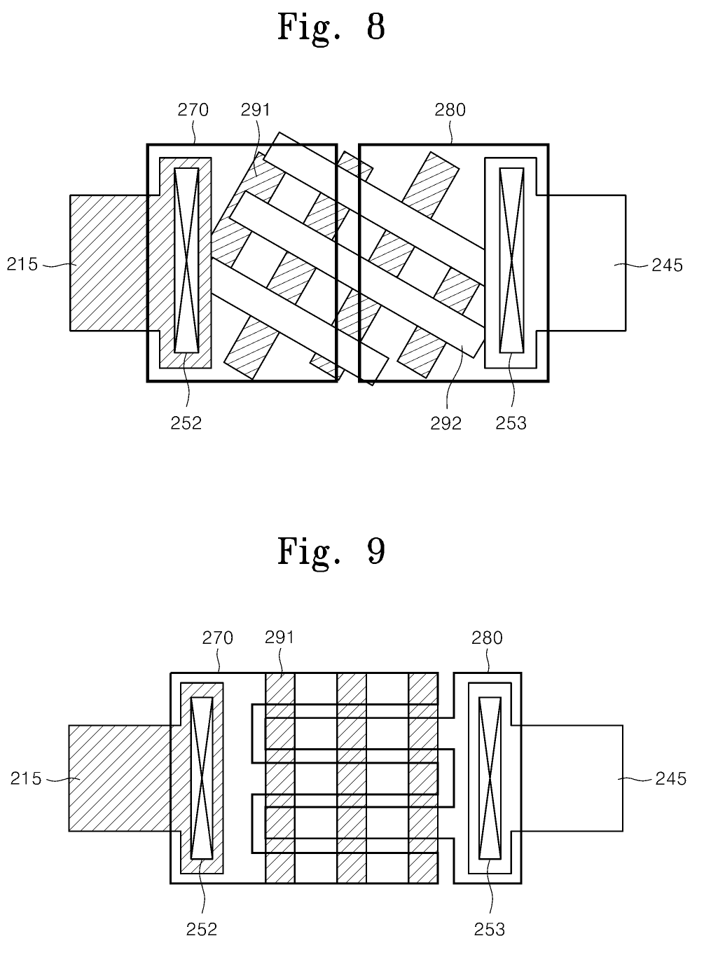

Referring to FIGS. 7 and 8, the first lower electrode 291 and the second lower electrode 292 have a rectangular shape. For example, the first lower electrode 291 and the second lower electrode 292 may be connected to the first sensing line 215 and the second sensing line 245, respectively, as shown in FIG. 7. In an exemplary embodiment of the present invention, portions of each of the first lower electrode 291 and second lower electrode 292 are alternately disposed under the first sensing electrode 270 and the second sensing electrode 280, respectively, and are arranged substantially parallel to each other.

Also, as shown in FIG. 8, the first lower electrode 291 and the second lower electrode 292 overlap under the first sensing electrode 270 and second sensing electrode 280. More specifically, for example, portions of the first lower electrode 291 may be arranged in an oblique direction substantially in parallel with each other, while portions of the second lower electrode 292 are arranged in parallel with each other in another oblique direction substantially perpendicular to the portions of the first lower electrode 291. As a result, the portions of the first lower electrode 291 and the portions of the second lower electrode 292 overlap each other, and portions thereof may protrude outside of the first sensing electrode 270 and the second sensing electrode 280, as shown in FIG. 8.

Referring to FIG. 9, the first sensing electrode 270 and the second sensing electrode 280 each have predetermined shapes, portions of which are alternately arranged in parallel with each other. For example, N portions of the first sensing electrode 270 protrude toward the second sensing electrode 280 and N-1 portions of the second sensing electrode 280 protrude toward the first sensing electrode 270. In an exemplary embodiment of the present invention, the value of N is a natural number greater than 1.

In an exemplary embodiment of the present invention, the N portions of the first sensing electrode 270 and the N-1 portions of the second sensing electrode 280 are alternately arranged in parallel with each other and substantially face each other, as illustrated in FIG. 9. For example, the N-1 portions of the second sensing electrode 280 are disposed between adjacent N portions of the first sensing electrode 270. As a result, the first sensing electrode 270 and the second sensing electrode 280 effectively prevent touch sensitivity from deteriorating due to a defect in alignment of the touch spacer 141 over the first sensing electrode 270 and/or the second sensing electrode 280.

The first sensing electrode 270 and the second sensing electrode 280 according to alternative exemplary embodiments are not limited to the shape shown in FIG. 9. For example, the first electrode 270 and the second electrode 280 may be formed in various shapes, including, for example, an L-shape, a U-shape or an I-shape, but alternative exemplary embodiments of the present invention are not limited thereto.

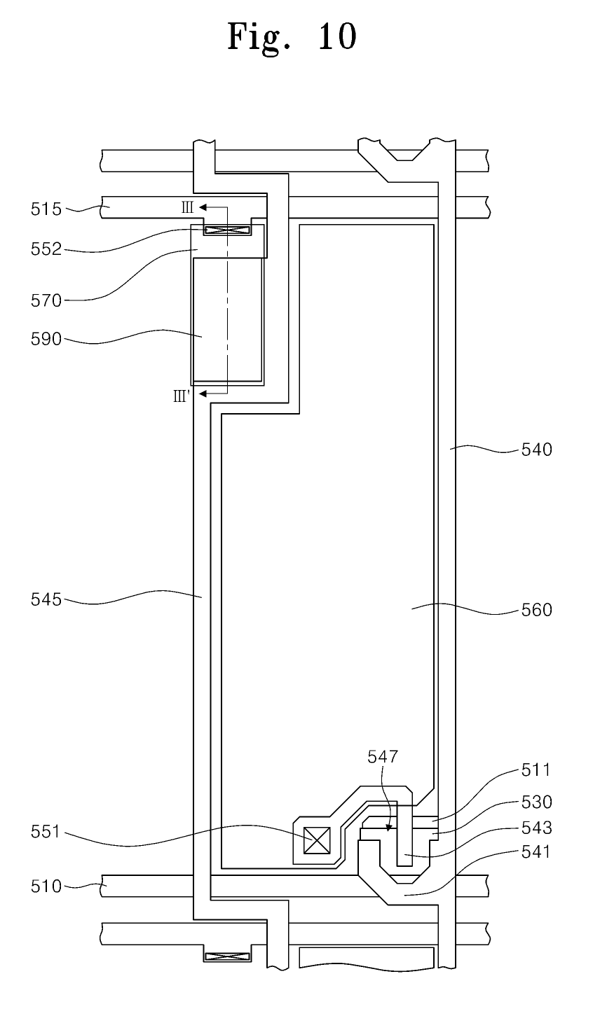

Hereinafter, a display panel according to an alternative exemplary embodiment of the present invention will be described in detail with reference to FIGS. 10 to 12.

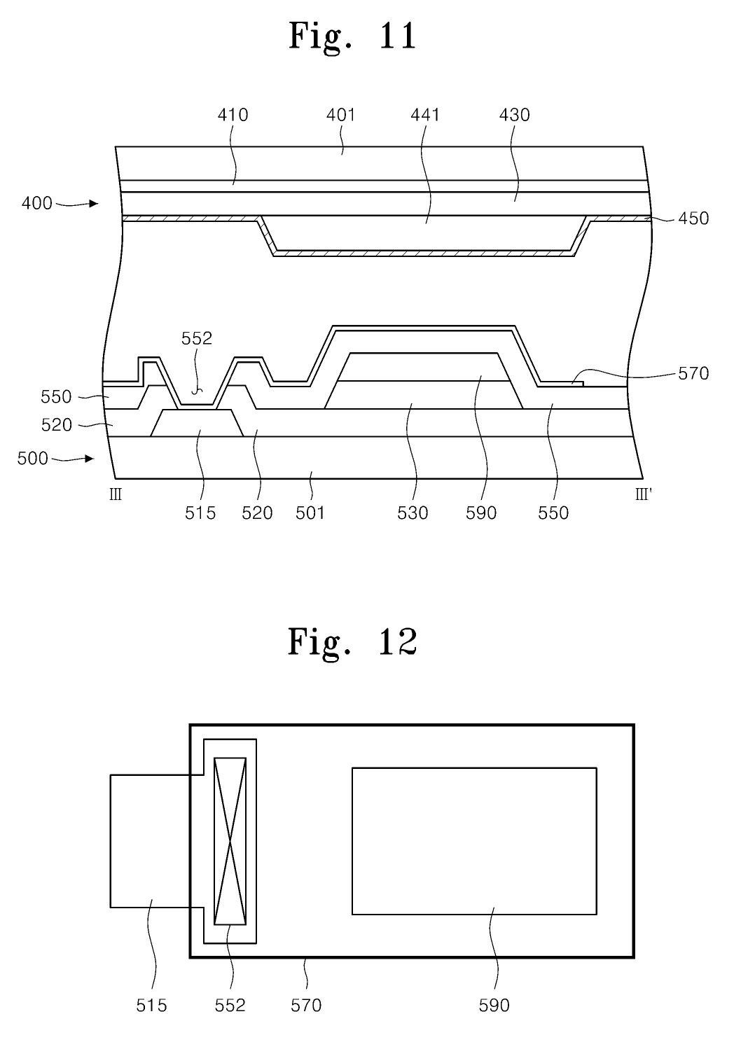

FIG. 10 is a plan view of a display panel according to an alternative exemplary embodiment of the present invention, FIG. 11 is a partial cross-sectional view taken along line III-III′ of FIG. 10, and FIG. 12 is a plan view of a lower electrode of the display panel according to the alternative exemplary embodiment of the present invention shown in FIG. 10.

Referring to FIGS. 10 to 12, a display panel includes a first substrate 400 and a second substrate 500 facing the first substrate 400.

In further detail, the first substrate 400 includes an upper substrate 401, a black matrix 410 disposed on the upper substrate 401, an overcoat layer 430, a touch spacer 441, and a common electrode 450, as shown in FIG. 11. In FIGS. 10 to 12, same reference numerals will be used to refer to the same elements as shown in FIG. 1, and any repetitive detailed description thereof will hereinafter be omitted.

The second substrate 500 includes a lower substrate 501, a gate line 510, a first sensing line 515, a data line 540, a second sensing line 545, a thin film transistor 547, a pixel electrode 560, a sensing electrode 570.

The gate line 510 is extends in the first, for example, horizontal, direction on the lower substrate 501 and includes a gate electrode 511 branching from the gate line 510.

The first sensing line 515 includes a same material as the gate line 510 and extends in the first direction substantially parallel to the gate line 510.

The data line 540 extends in a second, for example, vertical, direction on the lower substrate 501. The data line 540 includes a source electrode 541 branching from the data line 540 and a drain electrode 543 spaced apart from the source electrode 541. The source electrode 541 and the drain electrode 543 partially overlap the gate electrode 511.

The second sensing line 545 includes a same material as the data line 540 and extends in the second direction substantially parallel to the data line 540.

The thin film transistor 547 includes the gate electrode 511, a semiconductor layer 530, the source electrode 541 and the drain electrode 543. The semiconductor layer 530 overlaps the gate electrode 511 while a gate insulating layer 520 is interposed therebetween to form a channel between the source electrode 541 and the drain electrode 543.

Referring to FIG. 11, the protective layer 550 is disposed above the thin film transistor 547 and the gate insulating layer 520 to cover the thin film transistor 547 and the gate insulating layer 520. As a result, the thin film transistor 547 is electrically insulated from the pixel electrode 560. The protective layer 550 include a first contact hole 551 and a second contact hole 552 which partially expose the drain electrode 543 and the first sensing line 515, respectively, therethrough.

The pixel electrode 560 is arranged on the protective layer 550 and is connected to the drain electrode 543 through the first contact hole 551.

Still referring to FIG. 11, the sensing electrode 570 and the pixel electrode 560 include a transparent conductive material such as ITO, IZO or ITZO, for example. In addition, the pixel electrode 560 is disposed on the protective layer 550. The sensing electrode 570 is connected to the first sensing line 515 through the second contact hole 552. The sensing electrode 570 contacts with the common electrode 450, which surrounds the touch spacer 441, when pressure is applied to the touch spacer 441. Specifically, the sensing electrode 570 has an upper surface which protrudes away from the protective layer 550 toward the touch spacer 441 to a predetermined height above the lower electrode 590.

The lower electrode 590 has a size smaller than a size of the sensing electrode 570, as shown in FIG. 12. The lower electrode 590 may be formed using a same data metal as the second sensing line 545. In addition, the lower electrode 590 may be formed to have a circular shape, an oval shape or a polygonal shape, but alternative exemplary embodiments are not limited thereto.

Still referring to FIG. 11, the semiconductor layer 530 may be disposed under the lower electrode 590. In an exemplary embodiment of the present invention, a step difference of the sensing electrode 570 is formed due to the lower electrode 590 disposed under the sensing electrode 570. However, the step difference of the sensing electrode 570 may be formed by patterning the gate insulating layer 520 or the protective layer 550. The lower electrode 590 enables the sensing electrode 570 to protrude so that the upper surface of the sensing electrode 570 protrudes toward the touch spacer 441. In addition, a corner of the sensing electrode 570 which protrudes toward the touch spacer 441 may abrade an alignment layer (not shown), which is disposed thereon. As a result, a conduction efficiency between the sensing electrode 570 and the common electrode 450 increases, thereby further effectively improving touch sensitivity.

The sensing electrode 570 of the display panel also provides first coordinate information. For example, the sensing electrode 570 provides x-axis coordinate information and y-axis coordinate information through the second sensing line 545 when the sensing electrode 570 has contact with the common electrode 450. The display panel provides second coordinate information through the sensing electrode 570 formed in another pixel, which is not illustrated in FIG. 10. Accordingly, the sensing electrode 570 is connected to the lower electrode 590, which is connected to the second sensing line 545 through the second contact hole 552.

According to the exemplary embodiment of the present invention as described herein, a display panel includes a sensing electrode having an embossed shape. At least one portion of the sensing electrode contacts a common electrode when pressure is applied to a touch spacer. Therefore, the display panel has a substantially reduce sensitivity difference caused by a difference in a contact region of the sensing electrode, and damage to the touch spacer by local stress concentration is effectively prevented.

Also, conduction efficiency between the common electrode and the sensing electrode is improved by abrading an alignment layer arranged on the sensing electrode. As a result, sensitivity of a touch position may be further effectively improved.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit and/or scope of the present invention as defined by the following claims.

What is claimed is:

1. A display panel comprising:
a first substrate;
a second substrate facing the first substrate;
a touch spacer disposed on the first substrate;
a common electrode disposed on the touch spacer; and
a sensing electrode disposed on the second substrate facing the touch spacer,
wherein a surface, facing the first substrate, of the sensing electrode has a step difference.

2. The display panel of claim 1, wherein the sensing electrode has an embossed shape which allows at least two protrusions of plural protrusions of the sensing electrode to make contact with the common electrode.

3. The display panel of claim 1, further comprising a lower electrode disposed between the sensing electrode and the second substrate.

4. The display panel of claim 3, wherein a shape of the lower electrode comprises one of a circular shape, an oval shape and a polygonal shape.

5. The display panel of claim 3, wherein the second substrate comprises:
a first sensing line;
a gate line including a gate electrode and being disposed in a same layer as the first sensing line;
a gate insulating layer disposed on the first sensing line and the gate line;
a semiconductor layer disposed on the gate insulating layer and which overlaps the gate electrode;
a second sensing line disposed on the gate insulating layer;
a data line disposed in a same layer as the second sensing line and on the semiconductor layer;
a protective layer disposed on the data line and including a contact hole formed therein, a portion of the data line being exposed through the contact hole; and
a pixel electrode disposed on the protective layer and which contacts the portion of the data line through the contact hole.

6. The display panel of claim 5, wherein the lower electrode comprises a same material as a material of at least one of the gate line, the data line and the semiconductor layer.

7. A display panel comprising:
a first substrate;
a second substrate facing the first substrate;
a touch spacer disposed on the first substrate;
a common electrode disposed on the touch spacer;
a first sensing line disposed facing a first portion of the touch spacer on the second substrate;
a second sensing line disposed facing a second portion, different from the first portion, of the touch spacer on the second substrate;
a first sensing electrode connected to the first sensing line; and
a second sensing electrode connected to the second sensing line,
wherein each of the first sensing electrode and the second sensing electrode comprise an embossed shape including at least one protrusion which protrudes toward the common electrode.

8. The display panel of claim 7, wherein each of the first sensing electrode and the second sensing electrode has an embossed shape which allows at least two protrusions thereof to make contact the common electrode.

9. The display panel of claim 7, further comprising
a first lower electrode disposed between the first sensing electrode and the second substrate; and
a second lower electrode disposed between the second sensing electrode and the second substrate.

10. The display panel of claim 9, wherein a shape of each of the first lower electrode and the second lower electrode comprises one of a circular shape, an oval shape and a polygonal shape.

11. The display panel of claim 10, wherein the first lower electrode and the second lower electrode are disposed in one of a same layer as each other and a different layer from each other.

12. The display panel of claim 9, wherein the second substrate further comprises:
a gate line disposed in a same layer as the first sensing line and which includes a gate electrode;
a gate insulating layer disposed on the first sensing line and the gate line;
a semiconductor layer disposed on the gate insulating layer and which overlaps the gate electrode;
a data line disposed in a same layer as the second sensing line on the semiconductor layer;
a protective layer disposed on the data line and which includes a contact hole formed therethrough, a portion of the data line is being exposed through the contact hole; and
a pixel electrode disposed on the protective layer, wherein the pixel electrode makes contact with the data line through the contact hole.

13. The display panel of claim 12, wherein each of the first lower electrode and the second lower electrode comprise a same material as a material of at least one of the gate line, the data line and the semiconductor layer.

14. The display panel of claim 13, wherein a plurality of protrusions of the first sensing electrode protrudes toward a plurality of protrusions of the second sensing electrode in a plan view.

15. A display panel comprising:
a first substrate;
a second substrate facing the first substrate;
a touch spacer disposed on the first substrate;
a common electrode disposed on the touch spacer;
a first sensing line disposed on the second substrate;
a second sensing line disposed on the second substrate; and
a sensing electrode connected to the first sensing line and the second sensing line, the sensing electrode including protrusions which protrude toward the common electrode to make contact with the common electrode.

16. The display panel of claim 15, further comprising a lower electrode disposed between the sensing electrode and the second substrate.

17. The display panel of claim 16, wherein a size of the lower electrode is less than a corresponding size of the sensing electrode.

18. The display panel of claim 16, wherein
the lower electrode comprises a same material as a material of the second sensing line, and
the lower electrode is disposed in a same layer as the second sensing line.

19. The display panel of claim 18, wherein the second substrate further comprises:
a gate line disposed in a same layer as the first sensing line and which includes a gate electrode;
a gate insulating layer disposed on the first sensing line and the gate line;
a semiconductor layer disposed on the gate insulating layer and which overlaps the gate electrode;
a data line disposed in a same layer as the second sensing line;
a protective layer disposed on the data line and which includes a contact hole formed therethrough, a portion of the data line being exposed through the contact hole; and
a pixel electrode disposed on the protective layer and which contacts the data line through the contact hole.

20. The display panel of claim 19, wherein
the semiconductor layer is disposed between the lower electrode and the second substrate, and
a portion of the semiconductor layer overlaps the lower electrode.
